(19) United States
(12) Patent Application Publication
(10) Pub. No.: US 2003/0193588 A1
(43) Pub. Date: Oct. 16, 2003

(54) Remote-control battery powered rain resistance self-video capturing camera mounting device

(76) Inventors: Siltex Peter Yuen, San Jose, CA (US); Silbert Yuen, San Jose, CA (US)

Correspondence Address: Siltex Peter Yuen, 2765 Henessy Drive, San Jose, CA, 95148, US

(21) Appl. No.: 10/109,493

(22) Filed: Mar. 28, 2002

(51) Int. Cl. H04N 5/335

(52) U.S. Cl. 348/275

(57) ABSTRACT

A wirelessly remote control battery powered self-video capturing capability camera mounting device system especially for handheld video camera. It provides the user the ability to control the video capturing direction of the handheld video camera from a distance away. The video camera mounting stage provides polar rotational movement both horizontally and vertically. The rotational movement is controlled by remote device as the input instructional device by the user. The signal is then transmitted to the video camera mounting stage via wireless signal transmission. The camera mounting stage receives the signals and generates functions to drive the designated motors to move the camera video capturing direction to the decided direction. The user can then confirm the results from the LCD screen of the video camera and fine tune the direction of the video camera mounting stage. This device provides the user the opportunity to be in the video while taking video pictures for the occasion. The device is rain resistance and provides a rain shield for the video camera.

### FIELD OF INVENTION

The present invention relates generally to portable video camera filming directional control equipment, and more particularly to battery powered wirelessly remote control weather resistance personal hand-held video camera accessory. This invention requires the user's interaction to determine the correctives of the direction via a generic video camera during the filming process. This present invention is rain resistance and suitable for outdoor application.

### BACKGROUND OF THE INVENTION

Personal handheld video camera has been very popular for many years. People use them in filming of indoor and outdoor event everyday. However, the camera operators are usually not in the film themselves. Sometimes tripods are used but still require someone to keep moving the filming direction in order to capture the whole occasions momentarily. It is a shame when reviewing the memory of the filmed video and the head of household is always not in the film.

It is always a possibility for the video camera to get wet when it is mounted on a tripod when filming home events in a cloudy day where rain is unpredictable especially in tropical climate. Sometimes video camera can be damaged by rain.

Thus there is a need for a video camera stand to provide the operator to control the filming direction from a remote distance. This camera stand should simulate a person's hand such that it can rotate back and forth horizontally and tilt up and down vertically. This will allow the operator to capture his/her own image in the video record.

Further, there is also a need for a video camera rain protector such that light rain or sudden rain will not damage the video camera. In addition, this device has to be low cost, portable, easy to operate, light weight, battery powered and rugged.

The present invention provides such a video camera mounting system.

### CROSS REFERENCE TO RELATED APPLICATIONS

Field of Search

Intern'l Class: G03B 017/00; H04B 007/24; H04L 7/24

U.S. Class 352/243, 242, 244, 038; 367/117

### U.S. Patent Documents

| | | | |
|---|---|---|---|
| 4,655,567 | Apr. 7, 1987 | Morley | 352/243 |

This patent is of old technology. Wireless remote controlling
electronics are expensive at that time and not readily available; and the
invention has nothing to do with the wireless technology.

| | | | |
|---|---|---|---|
| 5,073,824 | Jun. 15, 1990 | Vertin | 348/211 |

This invention is a very costly remote control and camera
combination. It is not a stand-alone portable camera mounting device for
generic video camera.

| | | | |
|---|---|---|---|
| 5,111,288 | Oct. 8, 1991 | Blackshear | 348/143 |

This invention is not wirelessly remote control.

| | | | |
|---|---|---|---|
| 5,179,421 | Jan. 12, 1993 | Parker | 356/139 |

This invention is using infrared (IR) as a measuring means for
position calculation.

| | | | |
|---|---|---|---|
| 5,181,120 | Jan. 19, 1993 | Hickey | 348/373 |

This invention is not wirelessly remote control.

| | | | |
|---|---|---|---|
| 5,436,542 | Jul. 25, 1995 | Petelin | 318/567 |

This invention is for telescopic cameras for surgery.

| | | | |
|---|---|---|---|
| 5,568,205 | Oct. 22, 1996 | Hurwitz | 348/732 |

This is an invention on wireless audio/video transmitter system,

### SUMMARY OF THE INVENTION

A wirelessly remote control self-video capturing rain resistance video camera mounting device system is portable, light weight, battery powered, rain resistance and suitable for both indoor and outdoor applications. It includes a device controller, a main system, a rain jacket for the main system and a transparent video camera rain shield.

The device controller includes electronic components and program, which receive input signals, generates signal functions and transmits the signal functions to the main system wirelessly.

The main system includes mechanical hardware to provide horizontal polar movement and vertical polar movement and video camera mounting device. It also includes electronic components and firmware program, which receive signal functions from the device controller wirelessly and provide electrical driving functions to control the mechanical hardware into precision fine rotational movement of the main system. It also provides the mounting base for the transparent video camera rain shield. The main system is battery powered with power saving features.

This device supports generic handheld video camera. In practice it gives the best results especially with the remotely controllable video camera, which have the capability of rotating the LCD screen to face the same direction as the video camera focusing direction. This allows the LCD screen to be viewed by the video-recording operator who will determine the preferred view and the zoom magnification to be video recorded. The operator can also instantaneously capture himself/herself into the video record by remotely control the video camera via the video camera controller device.

Other features and advantages of the invention will appear from the following description in which the preferred embodiments have been set forth in detail, in conjunction with the accompanying drawings.

### BRIEF DESCRIPTION OF THE DRAWINGS

FIG. 1 is the front plan view of the remote-control self-video capturing rain resistance portable video camera mounting system includes a handheld device controller, a main system, a rain jacket covering the main system and a video camera rain shield. In addition a generic handheld video camera is mounted inside the device with an operator holding a video camera remote controller unit to demonstrate the relative usage of the device.

FIG. 2 is the front plan view of the main system assembly according to the present invention.

FIG. 3 is the cross section view of the main system taken along the line 2-2 of FIG. 2.

FIG. 4 is the top plan view of the rotor base and motor with worm system subassemblies depicting a portion of the rotor base, a portion of the vertical motor-worm driver subassembly and a portion of the horizontal motor-worm driver subassembly according to the present invention.

FIG. 5 is the top plan view of the video camera mount subassembly depicting a portion of the mounting block, a portion of the video camera locking screw, a portion of the location pin and a portion of the camera seating pad according to the present invention.

FIG. 6 is the cross section view of FIG. 5 taken along 3-3 depicting a porting of the mounting block, a porting of the camera locking screw, a portion of the camera seating pad, the location pin, spring, and a portion of the spring holder according to present invention.

FIG. 7 is the top plan view of the rotor and electrical attachment subassembly depicting a portion of the rotor, a portion of the motor for vertical motion with motor cable connecting to the PCB assembly, a portion of the motor for the horizontal motion with motor cable feeding through the opening hole of the rotor and connecting to the PCB assembly; a portion of the PCB assembly with mounting screws, a portion of the battery holder with battery cable connecting to PCB assembly and mounted to the rotor by mounting screws according to the present invention.

FIG. 8 is the front view of FIG. 7 taken along 4-4.

FIG. 9 is the exposed front view of the horizontal polar motion mechanical driver system depicting a portion of the rotor, a portion of the stator base, the motor, torque coupler, the bearing, the washers, preload spring, the worm, the worm gear and a portion of the pivot shaft according to the present invention.

FIG. 10 is the top plan view taken along 5-5 of FIG. 9 of the horizontal polar motion mechanical driver system.

FIG. 11 is the front plan view of the vertical polar motion mechanical driver system depicting a portion of the stage subassembly, a portion of the pivot shaft, a portion of the vertical motion worm gear, the worm, a portion of the rotor base, a portion of the bearing, washers, preload spring, torque coupler, the motor and mounting screw according to the present invention.

FIG. 12 is the bottom plan view of the stator base depicting a portion of the stator base, traction feet and mounting screws according to the present invention.

FIG. 13 is the right plan view of the video camera rain shield mounted to the video camera mount subassembly depicting a portion of the video camera mount subassembly, mounting screws, a portion of the shield frame, a portion of the rain protector. A generic handheld video camera is install onto the video camera mount subassembly according to the present invention.

FIG. 14 is the cross section view taken along 6-6 of FIG. 13 illustrating the mating relationship between the shield frame and the worm gear.

### DETAILED DESCRIPTION OF THE PREFERRED EMBODIMENT

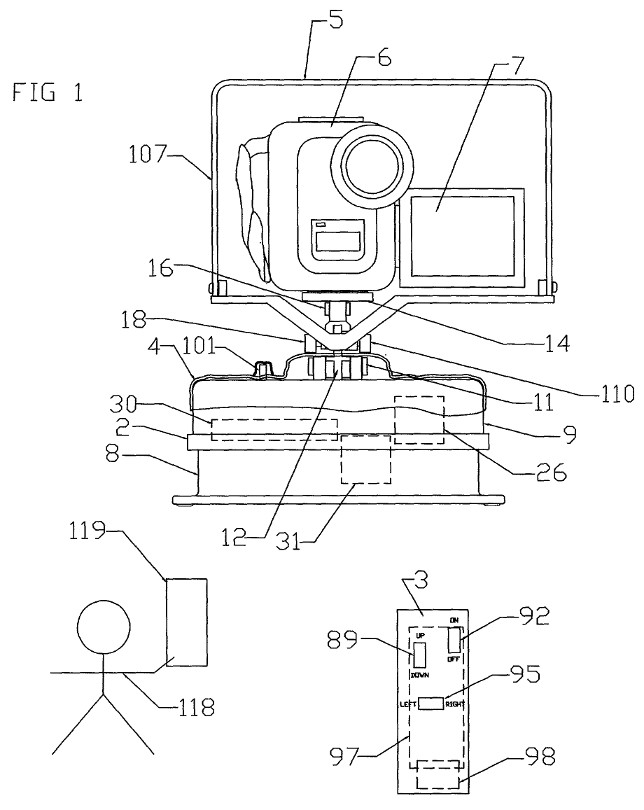

FIG. 1 is the front view of the overall system of the remote-control self-video capturing weather resistance portable video camera mounting system, which includes a handheld device controller 3, a main system 2, a rain jacket 4 covering the main system 2 and a camera rain shield subassembly 5, according to the present invention. As seen in the figure, a generic handheld video camera 6 with the LCD screen 7 is facing the front direction is mounted onto the main system 2 inside the camera rain shield 5.

The stator base 8 is the stationary reference of the main system 2. The rotor subassembly 9 rotates relatively to stator base 8 through the rotational axis. The horizontal rotational motion is driven by the horizontal motion motor-driver-subassembly 31 and has the capability to rotate in either clockwise or counterclockwise direction infinitely which is defined as without any angular limitation.

The vertical rotational tilt motion is driven by the vertical motion motor-driver-subassembly 26. The video camera is mounted to the video camera mounting subassembly 14 by the thumbscrew 16. The video camera mounting subassembly is mounted to the vertical motion worm gear 12 by the thumbscrew 18. The vertical motion worm gear 12 is assembled to the rotor subassembly by the pivot shaft 11. The vertical motion worm gear 12 is precisely mated to the vertical motion motor-driver subassembly 26. As a result the video camera mounting subassembly 14 rotates relatively to the rotor subassembly 9 by pivoting through the centerline axis of the pivot shaft 11.

Both the vertical motion motor-driver-subassembly 26 and the horizontal motion motor-driver-subassembly 31 are connected electrically to the main PCBA 30 and are all mounted to the rotor subassembly 9. Power switch 101 controls the power supply to the PCBA 30 and is also mounted to the rotor subassembly 9.

In practice, the operator 118 turns on the power of the video camera 6 and rotates the LCD screen 7 of the video camera towards the video camera focusing direction as in the FIG. 1. Then the operator 118 will switch the video camera 6 to camera mode, which allows the view to be shown on the LCD screen 7. The operator then turns on the power switch of the handheld controller device 3 and the power switch 101 of the main system 2. The operator 118 uses the handheld controller 3 to control the main system 2 to rotate and tilt the video camera 6. Switch 89 and switch 95 are spring return 3 position switches with normally set at center neutral position. When the switch 95 is activated to either left or right direction, the PCBA 97, which consists of electronic components and programmable components, of the device controller 3 will detect the input and generate a signal 98. This signal 98 can be a radio frequency signal or an infrared (IR) signal and is then emitted out wirelessly. The main PCBA 30 is equipped with signal receiver for either radio frequency signal or infrared (IR) signal matching with PCBA 97. This main PCBA 30 which consists of electronic components and programmable components, will detect the signal 98 and then generate the electronic driving functions to drive the horizontal motion motor-driver-subassembly 31. In results the rotor subassembly will rotate in either clockwise or counterclockwise direction accordingly.

When the switch 89 is activated to either up or down direction, the PCBA 97 of the device controller 3 will detect the input and generate a signal 98. This main PCBA 30 will detect the signal 98 and then generate the electronic driving functions to drive the vertical motion motor-driver-subassembly 26. In results the video camera mount subassembly will tilt up or down accordingly.

As the video camera moves to the preferred direction, the operator 118 can see himself/herself on the LCD screen and use the video camera remote controller 119 to zoom and record his/her own image.

The rain jacket 4 covers and seals off rain from the top and the upper portion of the side of the rotor subassembly 9. This rain jacket 4 is made of soft and elastic material such as polyester, nylon, rubber, and silicon rubber and may be transparent. This soft and elastic material permits the rain jacket 4 will stretch and fold as the vertical worm gear 12 tilts up and down. It also protects the power switch 101 from rain but permit the operator to turn the power switch 101 on or off from outside of the rain jacket 4.

The video camera rain shield subassembly 5 is mounted to the worm gear 12 by thumbscrew 110. The shield 107 is made of transparent material such as polycarbonate, acrylic or glass. It covers the top and all sides of the video camera 6 and the LCD screen 7. It protects the video camera 6 from rain by let the LCD screen to be viewed from outside. The video camera rain shield subassembly 5 should be large enough to facilitate a generic handheld video camera with the LCD screen flipped out to the side.

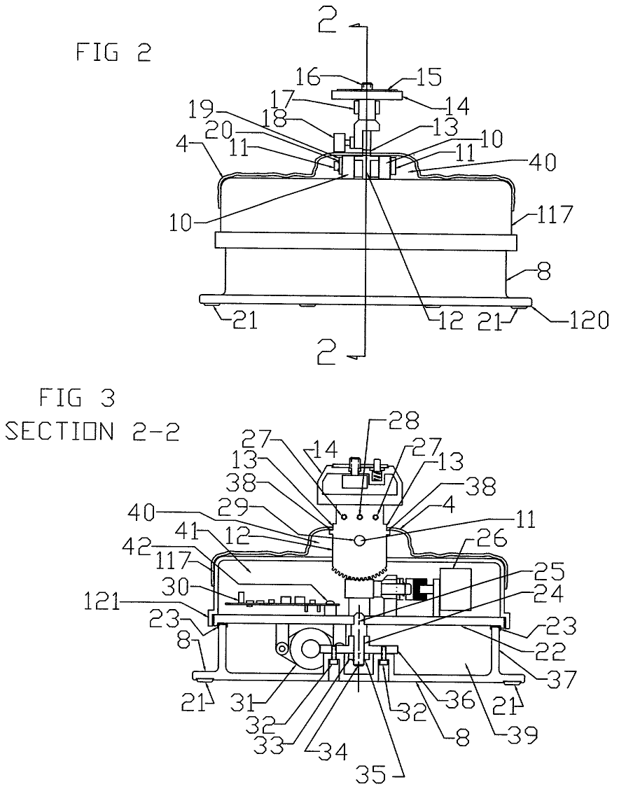

FIG. 2 is the front view of the main system 2, according to present invention. The stator base 8 is the base support of the complete system. As also seen in FIG. 2-FIG. 13, the rotor cover 117 protects the inside components from rain. The pivot shaft 11 passes through the pivot support arm 10, then the worm gear 12 and another pivot support arm 10. Then it is locked in place by the washer 19 and the OD retainer 20. As shown at least one pivot support arm 10 is used to facilitate the supporting structure. This allows the worm gear 12 to be able to pivot through the axis of the pivot shaft 11 relatively to the pivot support arm 10. The rain jacket 4 with an opening smaller than the neck 13 of the worm gear 12 slips over the neck 13 of the worm gear 12. The elastic property of the materal used of this rain jacket 4 provides a tight wrap around the neck 13 and forms a rain seal around the neck 13. The rest of the rain jacket 4 flare out and cover over the top and the upper portion of the vertical wall of the rotor cover 117. It results that all components covered by the rain jacket in the outside chamber 40 will be protected from rain.

The camera mount 14 is assembled to the worm gear by the thumbscrew 18 mounting at the threaded hole 28 of FIG. 3. As shown a least one thumbscrew will facilitate the assembly. The pad 15 provide a soft mounting surface for the video camera 6 which is assembled to the camera mount 14 by the thumb screw 16. The knurl head 17 of the screw 16 provides easy assembly processes for mounting and dismounting the video camera.

This present invention is a portable system. The traction foot 21 is made of rubber or silicon rubber type material and designed to have high coefficient of friction on the bottom surface. It is adhered to the bottom flare 120 of the stator base 8 by means of pressfitting, double sided adhesive tape or adhesive alike. At least 3 traction feet are used to facilitate the support of the main system. As shown, 6 feet are used for better balance. The traction feet provide friction against sliding along the surface where the main system 2 is resting on. This allows the system to function and be save to operate on some slightly unleveled surfaces such as shelves, tables, car roofs and hoods etc.

The bottom flare 120 extends out from the edge of the stator base 8. It provides better roll and tilt ratio that the center of gravity of the complete system with video camera 6 mounted will not be easily knock down accidentally.

FIG. 3 is the cross section view of FIG. 2 along 2-2. It shows the relationship between the rotor subassembly 9, rotor 22 and the stator base 8. The worm gear 36 is mounted onto the stator base 8 by the screw 32. As shown, at least one screw 32 is used to facilitate the assembly. The rotor 22 is mounted to the worm gear 36 by means of the pivot shaft 34 which is locked in place by the washer 33 and the OD retainer 35. The pivot shaft 34 is part of the rotor 22 by assembly, casting, molding or welding. The material choice for the rotor 22 and the pivot shaft 34 can be hard plastic, graphite or metal. Phosphorus bronze and stainless steel are the best material choice for the pivot shaft 34. The rotor 22 rotates through the center axis of the pivot shaft 34. The ID of the center hole of the worm gear 36 is slightly larger than the OD of the pivot shaft 34 and serves as the bearing surface 24 mating to the OD of the pivot shaft 34. The worm gear can be made of hard plastic, graphite or metal. Phosphorus bronze and stainless steel are the best material choice for this worm gear 36. Gear lubricant, grease or Teflon coating is applied to the bearing surface 24 and the OD of the pivot shaft to minimize friction.

The horizontal motion motor-driver subassembly 31 is mounted to the rotor 8 and provides the rotational direction to the rotor 8. As a result the rotor 8 rotates relatively to the stator base 8.

The weather seal 23 is assembled onto the wall 37 of the stator base 8. The weather seal is made of elastic material such as rubber and silicon rubber. The top surface of the seal 23 exerts a light pressure against the bottom surface of the rotor 22 and provides a seal against rain from entering into the inside chamber 39. The rotor cover lip 121 of the rotor cover 117 covers edge of the top surface of the rotor 22 and prevents rain from entering into the upper chamber 41.

The main PCBA 30 is mounted onto the rotor by screw 42 in the upper chamber 41. It is consisted of electronic components and firmware which will receive wireless signals 98 from the handheld device controller 3 and transfers them into electronic signal to drive the horizontal motion motor-driver subassembly 31 and the vertical motion motor-driver subassembly 26 respectively. The vertical motion motor-driver assembly 26 is mounted onto the rotor 22 inside the upper chamber 41.

The worm gear 12 rotates against the center axis of the pivot shaft 11. The ID of the center hole of the worm gear 12 is slightly larger than the OD of the pivot shaft 11 and serves as the bearing surface 29 mating to the OD of the pivot shaft 11. This pivot shaft 11 is made of metal and stainless steel is the best choice. The worm gear can be made of hard plastic like ABS or metal. Phosphorus bronze and stainless steel are the best material choice for this worm gear 12. Gear lubricant, grease or Teflon coating is applied to the bearing surface 29 and the OD of the pivot shaft to minimize friction.

The shoulder 38 of the worm gear 12 is the physical stop for the rain jacket 4 to slip any further downward. The center opening of the rain jacket 4 slips over the neck 13 of the worm gear 12. The inside perimeter of this opening is shorter than the outside perimeter of the neck 13 section of the worm gear 12. The elastic material property of the rain jacket 4 will exert a pressure along the contact area between the center opening of the rain jacket 4 and the surface of the neck 13 of the worm gear 12. This forms a seal against rain from entering into the outside chamber 40 area.

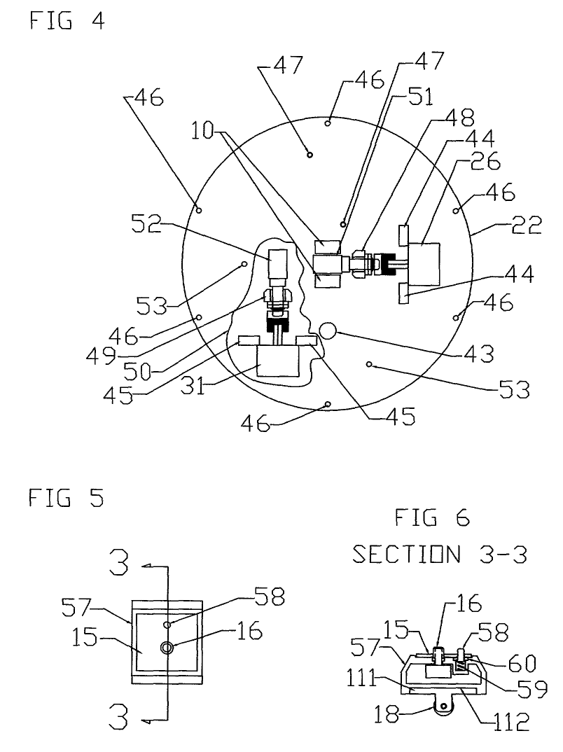

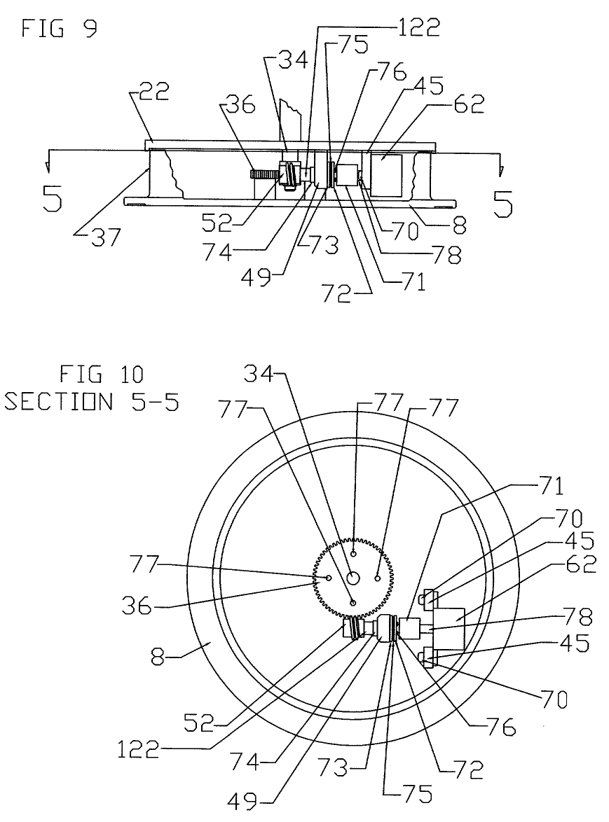

FIG. 4 is the isolated top view of the vertical motion motor-driver subassembly 26 and the horizontal motion motor-driver subassembly 31 mounted to the rotor 22 with a cutout 50 on the rotor 22 to show the horizontal motion motor driver assembly 31, which is mounted on the bottom side of the rotor 22. The opening 43 is a through hole of rotor 22 for the electrical cable to go through. Detail illustrations of the power transmission motion mechanism are shown on FIG. 9-FIG. 11.

Motor support arm 44 supports the vertical motion motor-driver subassembly 26.

Motor support arm 45 supports the horizontal motion motor-driver subassembly 31.

Bearing support 48 supports the vertical motion motor-driver subassembly 26.

Bearing support 49 supports the horizontal motion motor-driver subassembly 31.

Mounting holes 46 are for mounting the rotor cover 117.

Mounting holes 47 are for mounting the battery housing 65.

Mounting holes 53 are for mounting the PCBA 30.

FIG. 5 is the top view of the camera mount subassembly 14. The guide pin 58 is for orientation of the video camera 6 and thumb screw 16 is for mounting the video camera 6 against the mounting block 57 firmly with the pad 15 in between.

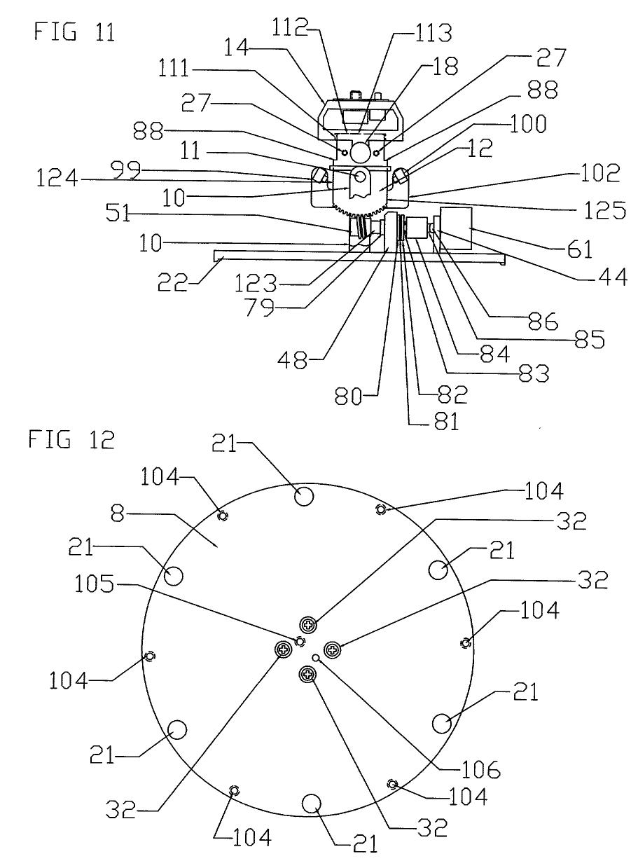

FIG. 6 is the section view of FIG. 5 along 3-3. The guide pin 58 is spring loaded by the spring 59 and is confined in place by the cap washer 60. The guide pin 58 can recess even to the pad 15 surface in event that the particular video camera does not have a guide hole. The recess pocket 111 of the mounting block 57 is designed to receive the extender edge 113 of the worm gear 12. Further detail is illustrated in FIG. 11.

Thumbscrew 18 is to be used to assemble the camera mount subassembly to the worm gear 12.

The mounting block can be made of hard plastic, graphite or metal.

The pad is made of soft and elastic material like rubber, silicon rubber and Poron pad.

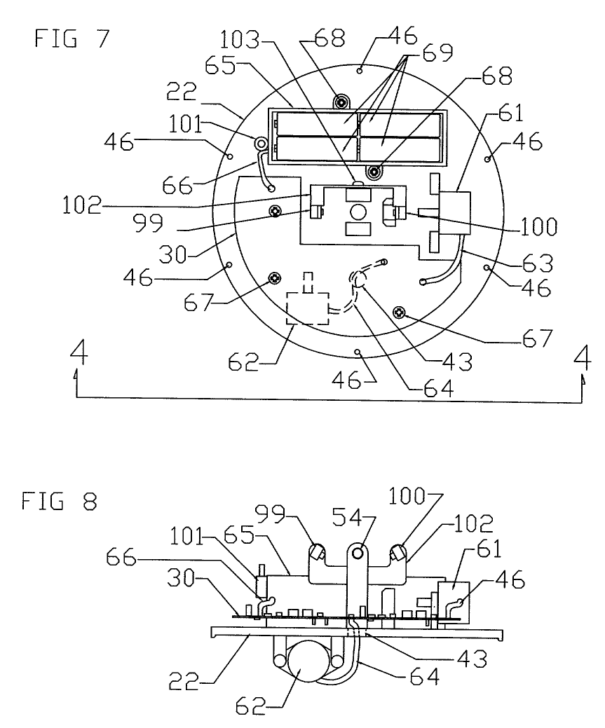

FIG. 7 is the top view isolating the rotor base electrical attachment subassembly and also seen in FIG. 8. All the electrical and power supplying batteries are mounted to the rotor. The voltage supplied by the batteries is at least 3 volt DC and not more than 27 volt DC. The batteries 69 are installed inside the battery housing 65, which is mounted to the rotor 22 by fastener 68 into the mounting hole 47 of the rotor 22. As shown, at least one fastener 68, which can be screw, rivet or other mounting mechanisms is used to facilitate the assembly. The power switch 101 is connected with one terminal to the battery power and one terminal to the PCBA 30 through cable 66. It turns on and off the power to the PCBA 30. This is one of the power saving feature of the main system 2. The PCBA 30 does not have to activate its components for sensing the signal 98 when the main system is not meant to be in operation. The motor cable 63 of the vertical motion motor 61 is connected to the PCBA 30. The motor cable 64 of the horizontal motion motor 62 is connected to the PCBA 30 from the bottom side of the rotor 22 through the opening 43.

The PCBA 30 is mounted to the rotor 22 by fastener 67 into the mounting hole 53 of the rotor 22. As shown, at least one fastener 67, which can be screw, rivet or other mounting mechanisms is used to facilitate the assembly.

The clockwise limit switch 99 and the counterclockwise limit switch 100 are mounted to the switch bracket 120 which is fastened to the pivot support arm 10 by at least one fastener, which can be screw, rivet or other mounting mechanisms is used to facilitate the assembly.

The clockwise limit switch 99, which is connected to PCBA 30, sends an electrical signal to the PCBA 30 whenever it is activated by the worm gear 12. The PCBA 30 is preprogrammed to stop the motor 61 to keep rotating any further in the clockwise direction. The counterclockwise limit switch 100, which is connected to PCBA 30, sends an electrical signal to the PCBA 30 whenever it is activated by the worm gear 12. The PCBA 30 is preprogrammed to stop the motor 61 to keep rotating any further in the counterclockwise direction.

The above set of limit switch defines the maximum tilt angle of the camera mounting subassembly 14.

FIG. 8 is the front view from line 4-4 of FIG. 7. The motor cable 64 of the horizontal motion motor 62 begins from the bottom side of the rotor 22 is fed through the opening 43 and connected to the PCBA 30.

FIG. 9 is the front view with a portion of the stator wall 37 cutout to show the mechanism inside. This figure illustrates the worm gear driven horizontal polar motion mechanism. The motor 62 is mounted to the rotor 22 by fastener 70 to motor support arm 45. The worm shaft 122 is assembled to the ID of the mechanical bearing 74. The OD of the mechanical bearing 74 is assembled to the bearing support 49. The mechanical bearing 74 can be plastic bearing, precision bushing, journal bearing, ball bearing or other bearing type mechanism to facilitate the bearing function. It is located in place by the washer 73, spring washer 75, washer 72 and OD retainer 76. The end of the worm shaft 122 is attached to torque coupler 71. The other end of the torque coupler 71 is connected to the motor shaft 78 as shown in FIG. 10. The torque coupler 71 transmits the motor power to the worm 52 and can tolerate any axial misalignment between the axis of the motor 62 and the axis of the worm 52. This torque coupler 71 can be bellow coupling, flexible shaft coupling or other coupling type mechanism to facilitate the above function.

FIG. 10 is the top section view of FIG. 9 along line 5-5. The worm gear 36 is mounted to the stator base 8 at the mounting holes 77 by at least one fastener, which can be screw, rivet or other mounting mechanisms to facilitate the assembly. As the result, the worm gear 36 is the fixed or stationary base of the horizontal rotational movement.

The worm 52 rotates at the same rate as the motor 78 and the worm gear 36 will pivot to the next tooth for every rotation of the worm 52. In the assembly the worm 52 and the worm gear 36 with the same pitch value are precisely mated to each other. The rotor 22 and all the components assembled to the rotor 22 rotate around the worm gear referencing to the center axis of the pivot shaft 34 whenever the motor 78 rotates. In practice worm gear system provides two advantages to the invention. Firstly, it prevents gear slippage and in turn the electronic system does not have to provide motor holding current to keep the main system 2 to lock in position. This is a unique power saving feature of this invention. Secondly, it provides a very high gear ratio such that a very low output torque motor 78 will be able to rotate the main system 2.

As shown in FIG. 10, this system of rotor 22 with all the components assembled to it can rotate relatively to the stator base in either clockwise or counterclockwise direction without angular limitation.

As switch 95 of the handheld device controller 3 receives a signal from the operator, the handheld device controller 3 will emit the wireless signal 98. The main PCBA 30 of the main system 2 will detect the signal 98 and provide an electrical function to the motor 62. As a result, the rotor subassembly 9 will rotate accordingly.

FIG. 11 is the isolated front view of the vertical rotational motion power transmission system. The motor 61 is mounted to the rotor 22 by fastener 86 to motor support arm 44. The worm shaft 123 is assembled to the ID of the mechanical bearing 79. The OD of the mechanical bearing 79 is assembled to the bearing support 48. The mechanical bearing 79 can be plastic bearing, precision bushing, journal bearing, ball bearing or other bearing type mechanism to facilitate the bearing function. It is located in place by the washer 80, spring washer 81, washer 82 and OD retainer 83. The end of the worm shaft 123 is attached to torque coupler 84. The other end of the torque coupler 84 is connected to the motor shaft 83. The torque coupler 84 transmits the motor power to the worm 51 and can tolerate any axial misalignment between the axis of the motor 61 and the axis of the worm 51. This torque coupler 84 can be bellow coupling, flexible shaft coupling or other coupling type mechanism to facilitate the above function.

In the assembly the worm 51 and the worm gear 12 are precisely mated to each other.

This invention provides an easy secured feature for the mounting of the video camera mount subassembly 14 to the worm gear 12. The extended edge 113 of the worm gear 12 is inserted into the recess pocket 111 of the mounting block 57. The recess surface 112 is resting against the extended edge 113 by gravity. A captive thumbscrew 18 is used to hold the video camera mount subassembly 14 safely to the worm gear 12 by finger-tightening captive thumbscrew 18 into threaded hole 28.

The worm 51 rotates at the same rate as the motor 61 and the worm gear 12 will pivot to the next tooth for every rotation of the worm 51. As results, The video camera mount assembly 14 pivots referencing to the pivot shaft 11 whenever the motor 61 rotates. In practice worm gear system provides two advantages to the invention. Firstly, it prevents gear slippage and in turn the electronic system does not have to provide motor holding current to keep the video camera mount subassembly 14 to lock in the prefer tilted angular position. This is a unique power saving feature of this invention. Secondly, it provides a very high gear ratio such that a very low output torque motor 61 will be able to tilt the camera mount assembly 14.

The left edge 124 of the worm gear 12 will touch and activate the clockwise limit switch 99 as the motor 61 keeps driving the worm gear 12 in pivoting in the clockwise movement direction. The clockwise limit switch 99, which is connected to PCBA 30, will send an electrical signal to the PCBA 30. The PCBA 30 is preprogrammed to stop the motor 61 to keep rotating any further in the clockwise direction.

The right edge 125 of the worm gear 12 will touch and activate the counterclockwise limit switch 100 as the motor 61 keeps driving the worm gear 12 in pivoting in the counterclockwise movement direction. The counterclockwise limit switch 100, which is connected to PCBA 30, will send an electrical signal to the PCBA 30. The PCBA 30 is preprogrammed to stop the motor 61 to keep rotating any further in the counterclockwise direction. The amount of allowable tilt angle of the video camera mounting subassembly 14 is defined as the angle of rotation between the activation of the clockwise limit switch 99 by the left edge 124 of the worm gear 12 and the activation of the counter clockwise limit switch 100 by the right edge 124 of the worm gear 12. A 70-degree allowable tilt angle is shown in FIG. 11. As switch 89 of the handheld device controller 3 receives a signal from the operator, the handheld device controller 3 will emit the wireless signal 98. The main PCBA 30 of the main system 2 will detect the signal 98 and provide an electrical function to the motor 61.

As a result, the video camera mounting subassembly 14 will tilt accordingly.

FIG. 12 is the bottom plan view of the stator base 8. At least one threaded mounting hole 104 is provide for the user to have a choice to mount the main system 2 to a non-horizontal surface or mount it firmly down to any surface. As shown in the figure, 6 mounting holes 104 are provided.

One ¼-20 UNC internal threaded hole 105 is provided for generic tripod mounting.

One guide hole 106 for generic tripod mounting orientation is provided.

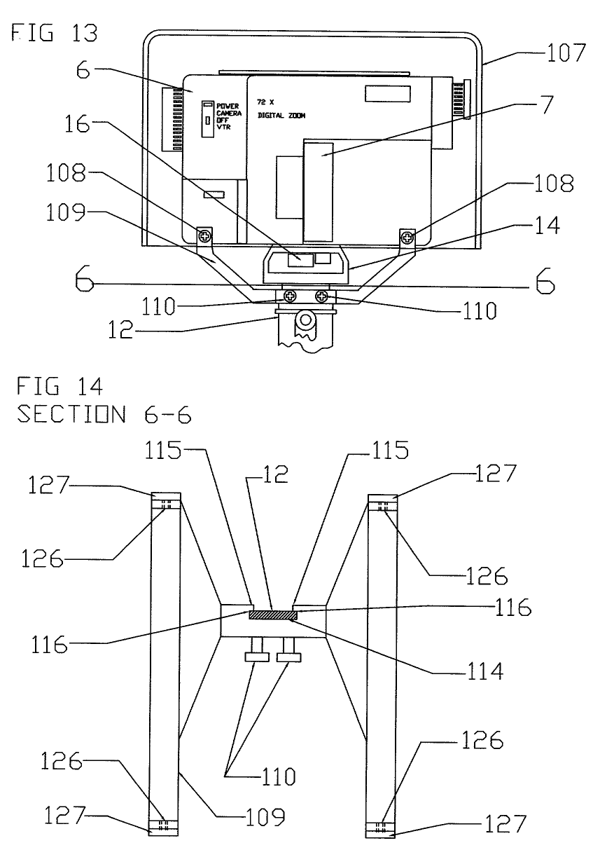

FIG. 13 is the right plan view of the video camera rain shield subassembly 5 assembled to the worm gear 12. The frame 109 of the video camera rain shield subassembly 5 is mounted to the worm gear 12 by at least one fastener 110 into the mounting hole 27. The fastener 110 can be screw or other mounting mechanisms, which can facilitate the assembly.

The rain protector 107 is mounted to the frame by at least one fastener 108 into the mounting hole 126 (shown in FIG. 14) of the frame. The fastener 108 can be screw or other mounting mechanisms, which can facilitate the assembly.

The rain protector 107 is made of transparent material like polycarbonate, acrylic or glass.

FIG. 14 is the cross section taken along line 6-6 of FIG. 13. This illustrates the mating relationship between the frame 109 and the worm gear 12. The material protrusions 115 of the frame 109 wrap around the corners 116 of the worm gear 12. The contact surface 114 of the frame 109 is against the worm gear 12. The assembly operation starts with placing the frame 109 over the top of the worm gear 12 and let the worm gear 12 to insert into the frame 109 where the material protrusions 115 act as the guide rail for worm gear 12. The second shoulder 88 of the worm gear 12 is the reference limit stop for the insertion process of the worm gear 12 into the frame 109. At least one fastener 110 is used to assemble the frame 109 the mounting hole 27.

The support flat 127 acts as the vertical registration surface for locating the elevation of the rain protector 107 referencing to the worm gear 12. In assembly, the rain protector 107 is placed onto the frame and rest on the support flat 127. At least two support flats 127 of the frame 109 is provided to support the rain protector 107 during assembly.

At least two mounting holes 126 are provided for assembling the rain protector 107 to the frame 109 by fastener 108. These mounting holes 126 act as the horizontal registration of the rain protector 107 referencing to the worm gear 12. Four support flats with four mounting holes 127 are shown in FIG. 14. This design provides an easy operation for mounting and dismounting the video camera rain shield subassembly 5 to the main system 2.

It will be appreciated that the sizes and shapes and dispositions of various main system, rain jacket, video camera rain shield and handheld device controller can be varied, without departing from the spirit and scope of the invention. Similarly, the size and location of mounting holes, housing, material protrusions and the like may be varied. While the sealing of the chamber spaces has been described with respect to use of gaskets or seal, other sealing mechanisms may instead (or in addition) be used. While the remote control portable video camera mounting device has been described with respect to application with handheld video cameras with capability of the LCD screen facing the same direction as the video camera focusing direction, the described system may be applied to other video cameras, including without limitation to supply mounting for digital cameras and cameras.

Modifications and variations may be made to the disclosed embodiments without departing from the subject and spirit of the invention as defined by the following claims.

What is claimed is:

1. A user-interactive battery powered portable, wirelessly remote control self-video capturing and rain resistance video camera mounting system comprising:
A stator base subassembly as the stationary support of said device.
A rotor subassembly rotates horizontally relative to the stator base.
A first electric motor, which is supported within the rotor subassembly, is coupled to power drive transmission mechanism, rotates the rotor subassembly relatively to the stator base without angular limitation.
A mechanical linkage is supported within the rotor subassembly and is perpendicular to the stator base, rotates through an axis parallel to the stator base.
A second electric motor, which is supported within the rotor subassembly, is coupled to power drive transmission mechanism, rotates the above said mechanical linkage vertically against the above said axis relatively to the stator base.
A video camera mount subassembly, which is supported by the said mechanical linkage, provides mounting mechanism to generic video camera.
A PCBA equipped with signal receiver, which can be radio frequency signals receiver and/or infrared (IR) signals receiver, electronic components, firmware to receive the said wireless signals and generates electronic functions to drive the first electrical motor to perform the horizontal rotation and the second electrical motor to perform the vertical rotation of the said mechanical linkage.
A battery holder, which is supported by the rotor subassembly, provides electrical power to the PCBA.
A battery powered handheld device controller apparatus is equipped with electronic components, firmware and electrical switches to receive user input; and then generate wireless signals, which can be radio frequency signals and/or infrared (IR) signals, and then emit the said signals out.
An internal threaded hole and a guide hole are provided in the center area of the bottom of the stator base to accommodate the generic mounting means of generic tripod and generic camera mounting devices.
A rain resistance cover protects the said main system and seals off rain from entering into the inside chambers of the said main system.
A transparent video camera rain shield subassembly, which is supported by the said mechanical linkage provides rain protection to generic video camera and allows the video camera to perform the video capturing functions in the rain.

2. The apparatus of claim 1, wherein said power transmission mechanism of the said first electrical motor is coupled by a torque coupler within the chain of mechanism to tolerate the axial misalignment between the said motor and the rest of the mechanism for the provision of the horizontal rotary motion of a camera mounting device.

3. The apparatus of claim 2, wherein said the said camera mounting device also include battery powered camera mounting device, solar powered camera mounting device, portable camera mounting device and DC powered camera mounting device.

4. The apparatus of claim 1, wherein said power transmission mechanism of the said second electrical motor is coupled by a torque coupler within the chain of mechanism to tolerate the axial misalignment between the said motor and the rest of the mechanism for the provision of vertical rotary motion of a camera mounting device.

5. The apparatus of claim 4, wherein said the said camera mounting device also include battery powered camera mounting device, solar powered camera mounting device, portable camera mounting device and DC powered camera mounting device.

6. The apparatus of claim 2, wherein said a worm and worm gear system is part of the power transmission mechanism coupled to the said first electrical motor for the provision of the horizontal rotary motion of a camera mounting device.

7. The apparatus of claim 6, wherein said the said camera mounting device also include battery powered camera mounting device, solar powered camera mounting device, portable camera mounting device and DC powered camera mounting device.

8. The apparatus of claim 6, wherein said first electrical motor does not require electrical holding current applied to the said motor in order to prevent mechanical slippage of the said first electrical motor and power transmission mechanism for the provision of the horizontal rotary motion of a camera mounting device.

9. The apparatus of claim 8, wherein said the said camera mounting device also include battery powered camera mounting device, solar powered camera mounting device, portable camera mounting device and DC powered camera mounting device.

10. The apparatus of claim 4, wherein said a worm and worm gear system is part of the power transmission mechanism to the said second electrical motor for the provision of vertical rotary motion of a camera mounting device.

11. The apparatus of claim 10, wherein said the said camera mounting device also include battery powered camera mounting device, solar powered camera mounting device, portable camera mounting device and DC powered camera mounting device.

12. The apparatus of claim 10, wherein said second electrical motor does not require electrical holding current applied to the said motor in order to prevent mechanical slippage of the said second electrical motor and power transmission mechanism for the provision of vertical rotary motion of a camera mounting device.

13. The apparatus of claim 1, wherein said the main system is equipped with a rain resistance seal between the said stator base and the said rotor subassembly to seal off rain from entering into the inside chambers of a camera mounting device.

14. The apparatus of claim 13, wherein said the said camera mounting device also include battery powered camera mounting device, solar powered camera mounting device, portable camera mounting device and DC powered camera mounting device.

15. The apparatus of claim 1, wherein said at least one limit switch is used to set and detect the vertical rotational limit of the said mechanical linkage of vertical rotary motion of a camera mounting device.

16. The apparatus of claim 1, wherein said at least portion of the said rain resistance cover is made of soft material to allow bending and folding of the said cover of a camera mounting device.

17. The apparatus of claim 16, wherein said the said camera mounting device also include battery powered camera mounting device, solar powered camera mounting device, portable camera mounting device and DC powered camera mounting device.

18. The apparatus of claim 16, wherein said the said rain resistance cover can comprise of more than on piece part assembled together.

19. The apparatus of claim 16, wherein said at least a portion of the said cover material can be transparent to allow the portion of the camera mounting device covered by the said cover to be visible.

20. The apparatus of claim 16, wherein said the entire said rain resistance cover or at least portion of the said rain resistance cover is made of elastic material such as rubber, polyester, nylon and silicon rubber alike.

21. The apparatus of claim 20, wherein said a stretch-seal method to used to protect the inside chamber from rain.
The said cover with an opening to wrap around at least a section of a portion of the camera mounting device where the length of the perimeter of the said section of the camera mounting device is larger than the length of the opening perimeter of the said section of the said cover.
The elastic properties of the said cover material exert a pressure around the said section of the camera mounting device and forms a rain resistance seal of a camera mounting device

22. The apparatus of claim 1, wherein said the video camera rain shield is supported by a camera mounting device.

23. The apparatus of claim 22, wherein said the said camera mounting device also include battery powered camera mounting device, solar powered camera mounting device, portable camera mounting device and DC powered camera mounting device.

24. The apparatus of claim 22, wherein said the video camera rain shield is supported by a mechanical linkage of the vertical rotational system of a camera mounting device.

25. The apparatus of claim 22, wherein said the video camera rain shield is supported by a mechanical linkage of the tilt section of the vertical rotational system of a camera mounting device.

26. The apparatus of claim 22, wherein said the video camera rain shield can comprise of more than one part.

27. The apparatus of claim 26, wherein said at least a portion of the one component of the video camera rain shield is made of transparent material of polycarbonate, nylon, polyester, acrylic, glass or alike.

28. The apparatus of claim 22, wherein said the video camera rain shield protects at least portion of the top plan surface of the video camera mounted to the said camera mounting device.

29. The apparatus of claim 22, wherein said the video camera rain shield protects at least a portion of any one or all of the four side surfaces of the video camera mounted to the said camera mounting device.
A said side surface is defined as a surface perpendicular to the top plan surface of the video camera.
The four side surfaces are defined as front, back, left and right surface.

30. The apparatus of claim 22, wherein said the video rain shield consists of:
A frame, supported by the said camera mounting device
A rain protector fastened to a frame by at least one fastener.

31. The apparatus of claim 30, wherein said the rain protector can be a single transparent piece covering the top, front, back, left and right surfaces.

32. The apparatus of claim 30, wherein said the said frame is supported by the mechanical linkage of the tilt section of the vertical rotational system.
Tilt section is defined as the portion of the camera mounting device that tilts vertically relative to the stator base.

33. The apparatus of claim 1, wherein said a battery powered handheld device controller comprises
It receives input from user through at least one electrical switch.
It generates radio frequency signals.
It emits the signals wirelessly to a camera mounting device with a radio frequency signal receiver to drive a servo motor or a stepper motor, which is coupled to power transmission mechanism to perform horizontal rotational clockwise and counterclockwise movements of a rotary stage relatively to a stationary base

34. The apparatus of claim 33, wherein said a battery powered handheld device controller is a variable speed controller.

35. The apparatus of claim 1, wherein said a battery powered handheld device controller comprises
It receives input from user through at least one electrical switch.
It generates infrared (IR) signals.
It emits the signals wirelessly to a camera mounting device with a infrared (IR) signal receiver to drive a servo motor or a stepper motor, which is coupled to power transmission mechanism to perform horizontal rotational clockwise and counterclockwise movements of a rotary stage relatively to a stationary base

36. The apparatus of claim 35, wherein said a battery powered handheld device controller can be a variable speed controller.

37. The apparatus of claim 1, wherein said a battery powered handheld device controller comprises
It receives input from user through at least one electrical switch.
It generates radio frequency signals.
It emits the signals wirelessly to a camera mounting device with a radio frequency signal receiver to drive a servo motor or a stepper motor, which is coupled to power transmission mechanism to perform vertical rotational clockwise and counterclockwise movements of a mechanical linkage supported within the said camera mounting device with a pivoting axis parallel to the stationary base

38. The apparatus of claim 37, wherein said a battery powered handheld device controller can be a variable speed controller.

39. The apparatus of claim 1, wherein said a battery powered handheld device controller comprises
It receives input from user through at least one electrical switch.
It generates infrared (IR) signals.
It emits the signals wirelessly to a camera mounting device with a infrared (IR) signal receiver to drive a servo motor or a stepper motor, which is coupled to power transmission mechanism to perform vertical rotational clockwise and counterclockwise movements of a mechanical linkage supported within the said camera mounting device with a pivoting axis parallel to the stationary base

40. The apparatus of claim 39, wherein said a battery powered handheld device controller can be a variable speed controller.

41. The apparatus of claim 1, wherein said an electrical motor driven rotor subassembly of a battery powered horizontal rotary camera mounting stage can rotate clockwise and counterclockwise relatively to its stationary base with no angular limitation.

42. The apparatus of claim 1, wherein said a camera mounting device apparatus:
Receives radio frequency signals wirelessly.
Generates at electrical functions to drive at least one servo motor or a stepper motor to perform horizontal rotational motion and/or vertical rotational motion.

43. The apparatus of claim 42, wherein said the said camera mounting device also include battery powered camera mounting device, solar powered camera mounting device, portable camera mounting device and DC powered camera mounting device.

44. The apparatus of claim 42, wherein said the said camera mounting device provides a fastener with an external threaded section for fastening to the threaded hole provided at the bottom of a generic video camera.

45. The apparatus of claim 44, wherein said the external threaded section of the said fastener is ¼-20 UNC external thread.

46. The apparatus of claim 1, wherein said a camera mounting device:
Receives infrared (IR) signals wirelessly.
Generates at electrical functions to drive at least one servo motor or a stepper motor to perform horizontal rotational motion and/or vertical rotational motion.

46. The apparatus of claim 46, wherein said the said camera mounting device also include battery powered camera mounting device, solar powered camera mounting device, portable camera mounting device and DC powered camera mounting device.

47. The apparatus of claim 45, wherein said the said camera mounting device provides a fastener with an external threaded section for fastening to the threaded hole provided at the bottom of a generic video camera.

48. The apparatus of claim 47, wherein said the external threaded section of the said fastener is ¼-20 UNC external thread.

49. The apparatus of claim 1, wherein said the bottom surface of the said camera mounting device provides at least one threaded mounting hole to adapt the threaded fastener provide by generic tripod for generic camera mounting.

50. The apparatus of claim 49, wherein said the said threaded mounting hole is of ¼-20 UNC internal thread.

51. The apparatus of claim 1, wherein said the bottom surface of the said camera mounting device provides at least one hole to adapt the guide pin provide by generic tripod for generic camera mounting orientation.

52. The apparatus of claim 1, wherein said the said video camera mount subassembly has
At least one recess hole to receive the said mechanical linkage, which is a component of the tilt section of the vertical rotational system of a camera mounting device.
The said mechanical linkage of the tilt section provides the bottom support to the said video camera mount subassembly.
Only a one fastener is enough to fasten the video camera mount subassembly securely to the said mechanical linkage of the tilt section.

53. The apparatus of claim 1, wherein said the center of gravity of a wireless remote control portable camera mounting device, which has at least one electrically driven horizontal rotary stage and at least one electrically driven vertical tilt function, is less than 6.00 inches, as measured perpendicularly from the reference surface where the said camera mounting device is resting on.

54. The apparatus of claim 53, wherein said the said camera mounting device also include battery powered camera mounting device, solar powered camera mounting device, portable camera mounting device and DC powered camera mounting device.

55. A method of controlling a camera mounting device remotely by a remote controller wirelessly:
A remote controller device generates signals, which also include radio frequency signals, infrared (IR) signals and emits the said signals wirelessly.
A camera mounting device detects the said signals, receives the said signals and generates electrical functions to drive at least one electrical motor, which includes AC motor, DC motor, servo motor, stepper motor, rotary voice coil motor and linear voice coil motor.
Wirelessly is defined as signals transmitted from the said remote controller to the said camera mounting device without passing through at least one electric conductor or fiber-optic cable directly and/or indirectly.
The said camera mounting device also includes battery powered camera mounting device, solar powered camera mounting device, portable camera mounting device and DC powered camera mounting device.
